(19) United States
(12) Patent Application Publication
(10) Pub. No.: US 2009/0182534 A1
(43) Pub. Date: Jul. 16, 2009

(54) ACCURATE MEASUREMENT AND MONITORING OF COMPUTER SYSTEMS

(75) Inventor: Charles Z. Loboz, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/972,624

(22) Filed: Jan. 11, 2008

(51) Int. Cl. G06F 15/00

(52) U.S. Cl. 702/186

(57) ABSTRACT

Described is a technology that improves the quality of data collected during computer system monitoring for subsequent analysis via dynamic adjustment, prediction, and/or elapsed collection time considerations. An interval is computed from an actual iteration start time and a desired interval; a subsequent data collection iteration occurs after a sleep time based on the computed interval. The sleep time may be based on an elapsed data collection time that accounts for delays in collecting the data, and/or based on a prediction obtained from historical data such as past iteration start times. When recorded, the elapsed data collection times may be used as a measure of error and/or for estimating an actual read time for a given iteration's counter read, as well as to estimate a number of processor time slices taken to collect the data, which may be used in the time estimate and/or in the measure of error.

### BACKGROUND

When monitoring a computer system, such as a server or a personal computer, a software-based monitor is used, which in general provides snapshot descriptions of the system state at various times. In one typical arrangement that has been in use for many years on a variety of platforms, the monitor periodically collects information about the system state, such as every few seconds or minutes, and then (optionally) stores the information in association with a timestamp in a persistent store. The collected information, which generally comprises the values of system counters at the time of sampling, such as for measuring CPU operations, disk operations and so forth, may then be analyzed.

In general, to collect the samples for a given test, the monitor sleeps for a defined interval, or a timer is used to trigger the monitor to collect the next sample set at the next interval. The sleep technique fails to account for the time taken to collect the data; the timer technique factors in this collection time, but still does not account for other delays, which may be cumulative. As a result, with either technique, software-based monitoring suffers from accuracy problems, including misleading data and lost samples.

In some measuring/monitoring environments, such inaccuracy (e.g., computed as a relative error percentage) is acceptable. However, some environments require more accurate monitoring where such inaccuracy is not acceptable. For example, lost samples poses a problem when comparing data from consecutive days, because each set has a different number of data samples and a different effective average sampling time. Thus, when seeking accurate measurements, including when measuring at a relatively high rate of sampling, existing monitoring mechanisms are not acceptable in certain environments.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which the quality of data collected during a computer system monitoring test is improved for subsequent analysis. In one example aspect, monitoring includes collecting data corresponding to the computer system's state. An interval is computed based upon an actual start time associated with this current iteration and a desired interval. A subsequent data collection iteration is performed after waiting for the computed interval. The computed interval may be further based on an elapsed data collection time that accounts for any delay in collecting the data. In another example aspect, computing the interval may include adjusting a sleep time based on a prediction obtained from historical data, e.g., of actual past iteration start times.

By computing the interval based on an actual system time to dynamically adjust the sleep time, samples are not lost, as data collection is more evenly performed at a steadier rate, and is performed closer to the desired interval. Further, a prediction based on historical data moves the start time closer to that desired. Either dynamic adjustment or prediction, or a combination of both, improves data quality.

In another aspect, by recording an elapsed data collection time in association with the data collected in each iteration, the elapsed data collection time may be used as a measure of error when later analyzing the data collected in that current iteration. The elapsed data collection time may also be used in estimating a time value corresponding to when each part (e.g., counter) of the data collection process was actually read. The elapsed data collection time may be further used to estimate a number of processor time slices taken to collect the data; the number (of one or more processor time slices) may be used in estimating the time value for when each counter was actually read, and/or in computing a measure of error associated with reading a given counter.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example aspects of monitoring a computer device using timing mechanisms.

FIG. 2 is a flow diagram representing example steps taken to collect sample set data including adjusting a sleep time for collecting a subsequent sample set.

FIG. 3 is a timing diagram representing example collection times and intervals illustrating how a dynamic adjustment timing mechanism compensates for actual timing to provide more accurate data collection.

FIG. 4 is a timing diagram representing example collection times and intervals illustrating how a dynamic delay prediction mechanism predicts delays to provide more accurate data collection.

FIG. 5 is a general representation of example components that may be used to process collected data to provide data analysis results.

FIG. 6 is a flow diagram representing example steps taken to process collected data for data analysis.

FIG. 7 shows an illustrative example of a computing environment into which various aspects of the present invention may be incorporated.

### DETAILED DESCRIPTION

Various aspects of the technology described herein are generally directed towards improving the quality and accuracy of data collected by a system monitor, and thereby provide for improved data analysis of the collected data. In one aspect, one or more timing mechanisms adjust sampling intervals to provide more timely and consistent sample sets for subsequent analysis. In another aspect, the uncertainty of errors associated with collected data is reduced and otherwise computed to facilitate better data analysis.

While many of the examples herein are described with respect to a computer system such as a server or personal computer, it is understood that these are only examples, and that any computing device or set of devices capable of system state monitoring for data analysis may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in software-based measurement and monitoring in general.

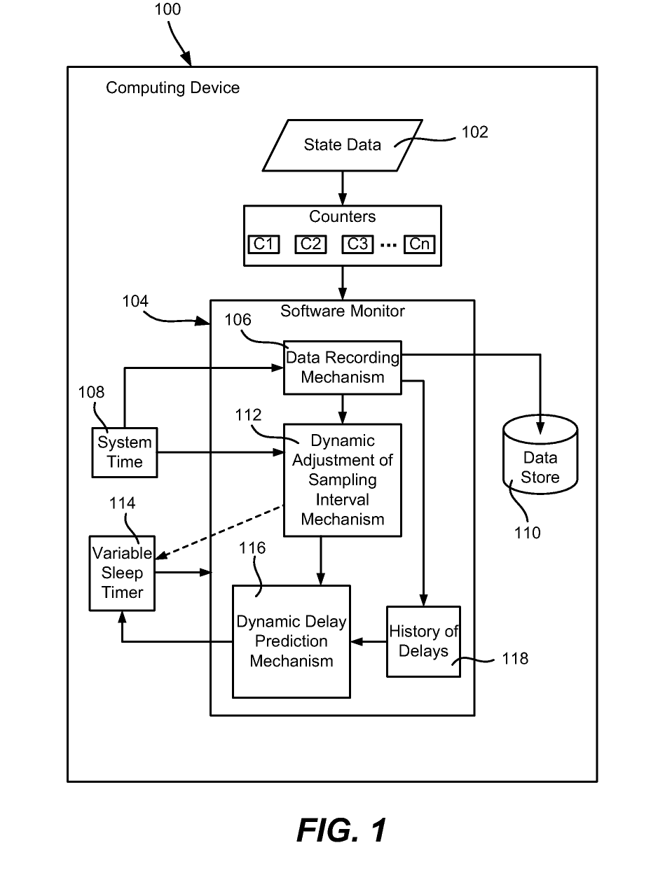

Turning to FIG. 1, there are shown example components which may be used to implement various aspects of accurate computer system measurement and monitoring of a computing device 100. In general, as is known in computer monitoring, various state data 104 is captured by counters C1-Cn. While no particular number of counters is required for a given set of desired data, such counters typically number on the order of hundreds. Examples of counters include a counter that captures processor usage, another that captures disk input-output (I/O) operations, and so forth.

In general, a software monitor 104 periodically wakes up or is woken up by a timer (at an interval set by a test person for example, hereinafter a “tester”), and includes a data recording mechanism 106 that gets the system time 108, collects the counter values C1-Cn in a sample set, and records the sample set along with a timestamp corresponding to the system time in a data store 110; (in general, this is referred to as “sampling” herein) The software monitor 104 then goes back to sleep until the next sampling iteration. However, as described below, the software monitor 104 does not actually wake up at the exactly scheduled time, but rather is subject to system delays.

More particularly, because the software monitor program has to share the computer system with other programs, the time at which the sampling occurs does not exactly match the requested sampling interval. By way of a simplified example, if sampling is to occur once every second, (scheduled to awake at exactly 1.0 second in this example), in actuality the sampling may not be started until 1.1 seconds because other processes may delay starting the sampling process by 100 milliseconds (ms). In general, the shorter the sampling interval that is chosen by the tester, the more that this delay becomes problematic.

As a result, one accuracy-related problem arises from the delays in the sampling times, caused by various artifacts of the operating system scheduling that cause sampling to start later than expected. This creates uneven effective time sampling intervals between samplings. However, some analytical methods assume or prefer time-series data that are evenly spaced in time.

Moreover, not only may the starting time of each sample be slightly time delayed, but these time delays may be cumulative. For example, if a sample (to collect a sample set of data) is taken 10 ms later than planned, the timing for every sample set taken thereafter may be shifted by these 10 ms. If there are three delays of 100 ms on three consecutive sample sets, the fourth sample set will be taken 300 ms later than expected, plus that fourth sample set's delay.

Such timing problems often lead to lost sample sets, even when a much larger sampling interval is chosen. For example, given an average delay of 50 ms and a fifteen second sampling interval, at the end of a day 288 seconds are lost, and 19 sample sets less than expected will have been collected. On heavily-loaded servers, as much as ten percent of sample sets may be lost. This prevents or greatly complicates certain types of data analysis, such as when comparing sample data collected over different days.

As shown in FIG. 1, the software monitor 104 includes a dynamic adjustment mechanism 112, which via the dynamic adjustment of sampling intervals, accounts for various delays in starting data collection. As will be understood, the dynamic adjustment mechanism 112 adjusts for delays caused by system scheduling as well as other possible delays (such as the amount of time to perform data collection), not just the sleep time. The dynamic adjustment mechanism 112 thus reduces the adverse effect of issues arising from delayed sampling start times.

To this end, constant system time rather than the fixed interval time is used to compute the desired start time for the next sampling. This may be accomplished by setting a sleep time or by setting an external (variable) sleep timer 114 (as shown in FIG. 1 via the dashed line). This reduces the unevenness of sampling times, taking into account any sources of delay, resulting in the samplings occurring much more evenly over time.

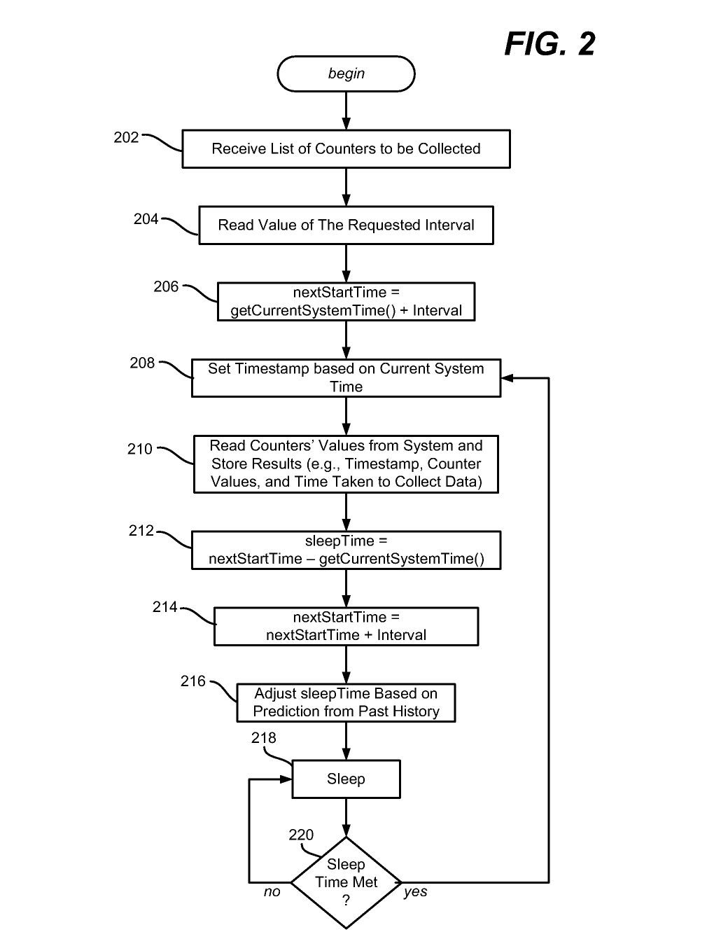

FIG. 2 shows how the system time 108 is used in dynamically adjusting the sampling interval. As will be understood, the example process of FIG. 2 keeps track of the system time and adjusts the sleep time in such a way that any delays, including from processor slicing time and/or data collection time, (and possibly other delays such as related to sleep, processor queuing and so forth) are taken into account.

Steps 202, 204 and 206 are generally one-time initialization operations, beginning at step 202 which represents preparing a list of counters to be collected, and step 204 which reads the value of the requested interval, e.g., as set by the tester. Step 206 initializes a variable representative of the next starting time, which is the current system time 108 plus the requested interval.

Step 208 begins the sampling iteration, including setting the timestamp for this iteration. Note that the loop beginning at step 208 essentially loops as long as required by the tester; thus although FIG. 2 does not show an explicit end, as can be readily appreciated, sampling may end in any number of ways, including by time, number of sampling iterations, or some other scheduled or unscheduled event.

Step 210 represents reading the counter values C1-Cn from the system and storing the results. Note that the tester can specify which set of subset of counters to read, and as described below, may specify a read order. Further note that not only are the counter values stored, but also the timestamp indicating when the sampling began, as well as (optionally, as described below) the amount of time taken to collect the data, e.g., a current system time after collection. For example, this may be the same current system time as used in step 212 (below), minus the current system time when collecting began.

Step 212 determines the sleep time, based on the nextStartTime variable previously determined (either during initialization or in a previous iteration) minus the current system time, which has changed since the time before reading began that corresponds to the timestamp. In other words, before initially starting data collection, or from a previous iteration once looping has begun, the current system time was read, added to the value of the interval, and set to the variable (nextStartTime). After data collection, the algorithm computes how much time remains until the end of the next interval (the start of the next collection), as measured by the system clock. Then the nextStartTime variable is updated with the interval value, at step 214.

Step 216 generally corresponds to the predictive mechanism 116 of FIG. 1, which attempts to separately fine tune the sleep time as described below.

Steps 218 and 220 represent sleeping for the sleep time, that is, as stored in the computed sleepTime variable at step 212. Note that although FIG. 2 shows steps 218 and 220 as a sub-loop for purposes of simplicity, awaking from the sleep is actually a time-based triggering event (rather than looping/regularly checking). When the sleep time expires, the process awakes and returns to step 208 for the next iteration.

By way of a numerical example, consider a test starting at system time of 10,000 ms with a requested interval of 1,000 ms. The nextStartTime is initially set to 10,000 ms+1,000 ms=11,000 ms. In this example, consider that the elapsed time taken to read the counter values is 100 ms in the first execution of the loop, whereby the system time read after that (at step 210) is 10,100 ms. The sleep time is thus calculated as 11000 ms−10100 ms=900 ms, and the nextStartTime is thus 12,000 ms.

Continuing with the example, the monitor thus goes to sleep for 900 ms (rather than the interval of 1,000 ms), but for this iteration, because this time the scheduler adds a 50 ms delay, the monitor actually wakes up after 950 ms. In the second execution of the loop, the system time read (at step 208) is thus 12,050 ms because of the scheduler delay. The nextStartTime is then 13,000 ms. If reading the counter values takes 300 ms in this iteration, the system time read at step 212 is 12,350 ms; the sleep time is thus computed at step 212 as 13,000 ms−12,350 ms=650 ms.

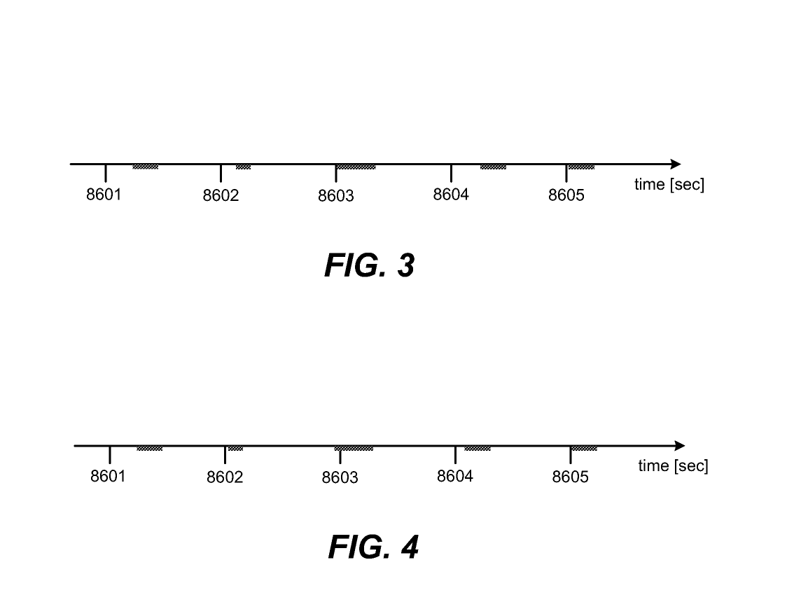

In this manner, the sleep time after data collection accounts for the any delays, including delays in both the scheduling time and the data collection time. In one example, resulting time intervals appear as represented in FIG. 3, where the solid lines below the timeline represent the data collection times.

As can be seen in FIG. 3, the data collection times are as close to the beginning of the interval as the system load and scheduling allow. When a delay happens, it has no effect on the sampling time of the next sample, because the dynamic adjustment mechanism 112 attempts to schedule the next sampling at the proper interval boundary. In effect, the interval value (the time between the start of two consecutive sampling periods) oscillates around the requested interval time. For example, looking at the samplings taken generally at times 8603 and 8604 seconds, it is seen that the effective interval time between these samplings is greater than one second, but that is attenuated by the effective interval time of less than one second between the samplings that generally occurred at the times 8604 and 8605 seconds.

In this manner, there is thus achieved the correct number of samples per time period as specified by the tester. In addition, the actual sampling times are closer to the beginning of each interval. Note that this does not remove the delay caused by scheduling, but rather removes the additive effect of such delay. Further, not all intervals are equal because the delay caused by scheduling still remains, however, the effective intervals between samples oscillate around the requested interval, not around some load-dependent value and/or system-dependent value larger than the interval. This allows comparing data from different days, because regardless of differences in load, the mean effective interval is the same as the requested interval.

Turning to a further explanation of step 216, for many data analysis algorithms, it is better if the starting times are as evenly spaced as possible. In one example implementation described herein, this may be implemented by the prediction mechanism 116 of FIG. 1. In this example implementation, the software monitor 104 keeps a recent history of delays 118 (e.g., for the last three or some other relatively small number) that occurred in the starting time of the sampling. The history of delays 216 is then used to predict the expected starting time delay at the next sampling time, which may then be used to appropriately adjust the sleep time to account for both the expected delay and data collection times, and any other possible delays. Note that although the example implementation uses historical data comprising recent delays, any of other various predictive methods may be used in a prediction mechanism. For example, instead of (or in addition to) using recently measured delays, other predictive techniques based on historical data include tracking the average processor queue size at a certain time (e.g., the same time on the previous day or previous week), and the like.

Using recent delay times as the historical data, for example, if the last m delay times are kept as the recent history, the sleep time computed for the next interval may be adjusted based on this history so as to aim for sampling to begin earlier than an exact interval boundary. As a more particular example, if m is three and each of the last three delays was 100 ms while the next interval is expected to start at 5000 ms, the next sampling start time is moved forward 100 ms (by lowering the sleep time by 100 ms) to compensate for the predicted delay of 100 ms, that is, to start at 4900 ms. An average of the previous m delay times is one very straightforward way to predict the next delay time, but as can be readily appreciated, virtually any suitable mathematical computation may be used for the prediction; any of various known methods of making statistically valid predictions of an expected delay may be employed.

If the delay occurs as predicted, sampling starts 100 ms late, exactly at 5000 ms, and it is seen that the estimate was correct. If less than the full predicted delay occurred, the next sampling starts earlier than expected; however, the history changes whereby the estimate of the delay is updated for the next iteration, so that the next prediction corresponds to a smaller (or eventually no) delay. Had the delay been larger than predicted, starting will have occurred slightly later, but this will increase the prediction time and thereby further reduce the sleep time, whereby the next sampling attempts to start even earlier.

FIG. 4 shows an example effect of such a predictive technique, which tends to shift the starting time of the collection earlier, unless and until it goes too early, in which event it shifts it back to later. Note that the collection times and intervals of FIGS. 3 and 4 are for illustrative purposes only and are not meant to represent actual collection times and/or intervals. However, generally comparing FIG. 3 (no prediction) and FIG. 4 (with prediction) shows that the prediction mechanism 116 tends to shift the sampling start times closer to the desired start times.

For example in comparing collection start times in FIG. 3 versus FIG. 4 and assuming that the desired start time is once each exact second, the collection just after time 8602 is shifted closer to the exact time in FIG. 4 as a result of prediction. In contrast, because the adjusted sampling that occurs generally around time 8603 is too early in FIG. 4, the prediction plus the actual delay pushed the collection scheduled for time 8604 later, but still closer to desired than that which took place FIG. 3.

Note that the prediction mechanism 116 of FIG. 1 (corresponding to step 216 of FIG. 2) is independent of the dynamic adjustment mechanism 112 of FIG. 1. As a result, such a prediction technique may be used by itself, or may not be used at all, or may be used in combination with dynamic adjustment.

As can be seen, dynamic adjustment and/or prediction improve data quality by keeping the sampling rate consistent, eliminating cumulative delays and thereby eliminating lost sample sets, and/or reducing unevenness in the starting times. As a result, each sampled data set is closer to its recorded timestamp. Further, statistical consideration issues that exist when trying to compare data from the server on several consecutive days are resolved. Still further, the reduction of the uneven effective time sampling intervals between samplings facilitates the use of analytical methods that assume or prefer time-series data that are evenly spaced in time.

Turning to another aspect of improving sampled data quality for subsequent data analysis, it is considered herein that the data collection time for each sampling may be different between sample sets. For example, if a collection of counters takes several hundred milliseconds of elapsed time (e.g., because the computer is heavily loaded or for other reasons), the monitor needs to consider that the last-collected collected values were likely obtained several hundred milliseconds later than the first collected values. As a result, even though all counter values in that sample are stored and marked with the same timestamp, they do not represent the actual values that existed in the system at the same time. This creates the potential for misleading interpretation of the data.

Thus, a second set of accuracy-related problems is caused by the variability of finite times required to collect the sample data from one sampling to another. In general, this is because data collection may take longer than one processor time slice to complete, whereby any number of processor time slices used by other processes may be in between any two processor time slices that are used for data collection. In practice, it has been seen that data collection times can vary among sample sets from tens to hundreds of milliseconds.

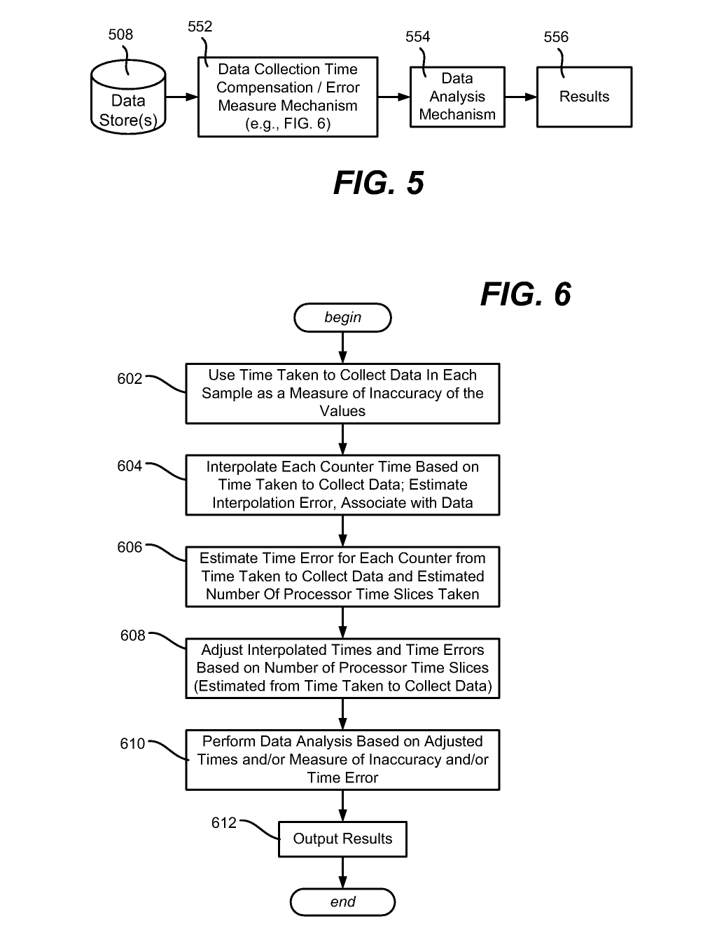

To mitigate the adverse effects of variable data collection times, while taking the sample, the elapsed time taken to collect the sample is recorded (e.g., at step 210 of FIG. 2 as described above). With this information, the remaining unevenness in data collection may be taken into consideration in the statistical analysis of the data collected by the monitor. Thus, when analyzing this data as generally represented in FIG. 5 (e.g., as analyzed as part of one or more data stores 508), the data collection times for each sample may be processed by a compensation mechanism/error measure mechanism 552 prior to (or in conjunction with) subsequent data analysis as represented by the block 554 to provide improved (or at least more relevant) results 556.

FIG. 6 summarizes various ways in which the data collection times, one for each sample, may be compensated for and/or used to determine measures of errors for use in data analysis. As will be understood, not all of the steps of FIG. 6 are required for compensation and/or measure of error determination in facilitating better data analysis.

As a first type of compensation, the elapsed time (the recorded taken to collect the sample) may be used as a measure of error, as generally represented in FIG. 6. A statistical package analyzing a set of data can use the measure of error to appropriately adjust the analysis.

As another type of compensation, instead of using the single timestamp for all counters of a sampling set, the relative position of a counter in the counter list and the elapsed data collection time recorded for that sampling may be used to estimate a more realistic time that any given counter was really collected. To this end, the differences in time between collecting the individual counters in the sample are assumed to be mathematically related (e.g., proportional) to the position of that counter in the monitor counter list. For example, if it takes two seconds to collect the samples and there are one-hundred counters on the list, is can be estimated that the counter number one-hundred was collected two seconds after the counter number one. This data may be used to analyze the overlap of intervals between two different counters, and to interpolate a more likely actual time for each counter.

Step 604 represents interpolating such a time for each counter, (although as can be readily appreciated, grouped subsets of counters may be treated together, e.g., counters one through ten may have one timestamp, counters eleven through twenty another, and so forth. Linear interpolation is one straightforward type of time compensation, although as can be readily appreciated, other mathematical methods may be used.

As also represented by step 604, the error of any time estimation itself may be estimated and associated with its corresponding data. That is, the estimate of the time of when a counter was really collected, and the elapsed time (or its portion), may be used as a measure of error associated with when the counter was really collected; for example, the first counter has close to zero error.

Compensation may also use an estimate of how many processor slices were used in the collection of that data sample. Note that the processor slice time may be obtained from the operating system, such as during initialization, and saved with the data set. Thus, for any counter that was collected, the number of slices into which data collection was split may be used as a factor in the estimate of time error, as generally represented by step 606. Moreover, the estimate of the time error for any given counter may be computed by combining one or more of steps 602, steps 604 and 606, e.g., using the elapsed time to collect the sample and the estimated number of processor slices that it took to collect the sample as measures of error.

Note that step 604 may be a relatively rough interpolation estimate that assumes linearity of sample collection times (if proportionality is used as the mathematical relationship). Straight linear interpolation is somewhat inaccurate when the monitor request is sliced into several processor time slices; nevertheless, it is still more beneficial than not in data analysis.

However, the data quality can be improved by knowing and compensating for the processor time slices, because with this information an estimate into how many slices the collection request was cut (from the ratio of elapsed time for each collection request versus the CPU slice time) may be made.

More particularly, further reasoning may be made from the spectrum of data collection times on given computer. The shortest data collection times are the ones collected uninterrupted, such as in a single time slice or in consecutive time slices. The longest data collection times are those with the largest number of interrupts, in two or more (but likely several) processor slices. For each sampling, an estimate may be made as to how many processor time slices the data collection required.

With this number-of-slices estimate, an estimate may be made as to which counters were read in which time slice. For example, if a four-hundred counter sampling took two time slices, the counters numbered one to two hundred can be considered in the first time slice, and counters numbered two-hundred one to four-hundred in the second time slice; the interpolated times for counters numbered two-hundred one to four-hundred can thus be adjusted with an offset value computed or interpolated for that second time slice. Step 608 represents adjusting the interpolated times based on time slice estimates. Note that this is only an estimate, although statistically valid.

In the above example, the counters closer to counter number one or closer to number four hundred are more likely to have been read in the properly guessed time slice, whereas it is more uncertain for counters closer to number two hundred whether a given counter was read in the first or second time slice. Thus, at step 608, the timing error value that may be associated with each counter (e.g., at step 606) may be recomputed or adjusted based on its position relative to the time slices.

Continuing with the same example, the uncertainty increases from zero or near-zero error at counter number one (because it is highly probable that counter 1 was read in the first time slice) to its highest uncertainty value around counter number two hundred, and decreases back towards zero for counter number four hundred (because it is highly probable that counter number four hundred was read in the second time slice). The time errors for each counter can be computed and/or adjusted based on this uncertainty value.

Thus, because it is not known where an allotted time slice ends with respect to reading the counters, any time-slice adjustment introduces error. However, this can be mitigated to an extent by considering the reading order. For example, putting the most important counters first (or last) makes so that will be read during the first time slice reduces error with respect to the most important counters.

Further, the reading order may be varied to control the error distribution. For example, given enough samplings, a random reading order distributes the error evenly among counters. Counters may be read in a backwards order every other time. Counters may be read with a different starting counter, e.g., if there are one hundred counters, counters number one to one hundred may be read in that order in the first iteration, counters two to one-hundred and followed by counter one in the second iteration, and so forth.

Further, a combination of the above ordering techniques may be employed. For example, if at least forty counters are assured to be read in the first time slice, the most important forty counters may always be read first, with the other counters beginning at counter forty-one read randomly, read alternating between forwards and backwards and/or read with a varied starting counter. In this manner, the first forty counters have zero error, with the time-slice estimation error more evenly distributed among the remaining counters.

### Exemplary Operating Environment

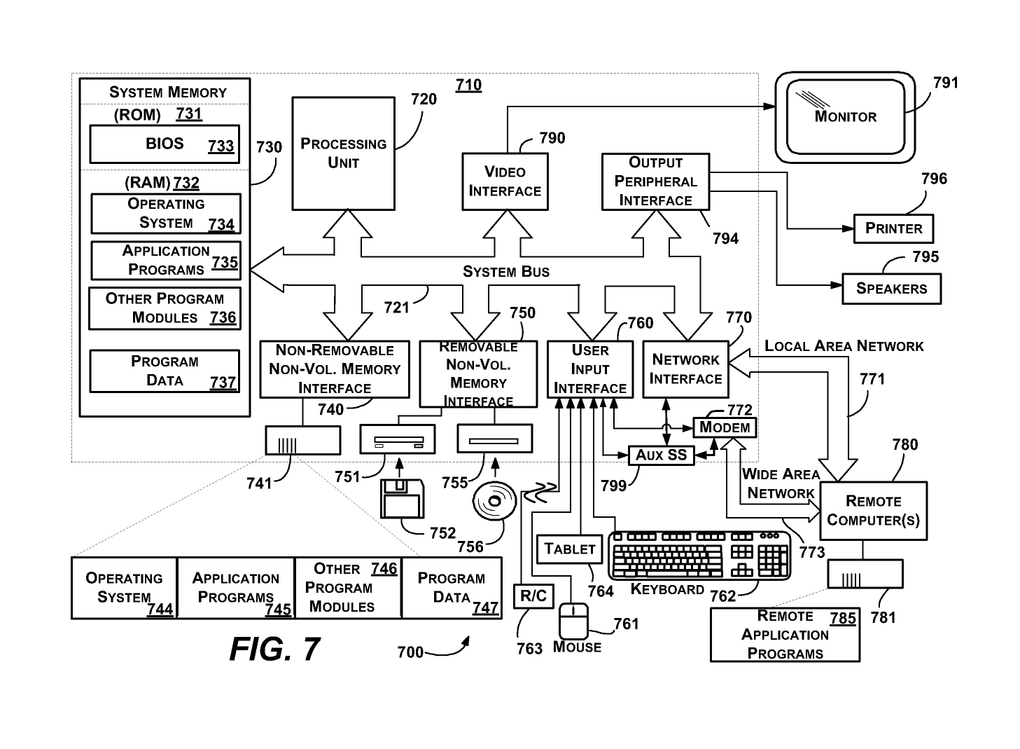

FIG. 7 illustrates an example of a suitable computing system environment 700 on which the examples of FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
(a) initializing a computer system monitoring test to obtain a data set comprising data corresponding to a computer system's states over a plurality of iterations;
(b) in a current iteration, collecting data corresponding to the computer system state and computing a computed interval based upon an actual start time associated with this current iteration and a desired interval;
(c) waiting for the computed interval; and
(d) returning to step (b) until the test is complete.

2. The method of claim 1 wherein initializing the computer system monitoring test comprises receiving a set of counters to be collected, and wherein collecting the data corresponding to the computer system state comprises reading the counters.

3. The method of claim 1 wherein computing the interval includes adjusting a sleep time based on a prediction obtained from historical data.

4. The method of claim 1 wherein computing the computed interval includes determining an elapsed data collection time to account for any delay in collecting the data.

5. The method of claim 4 wherein computing the computed interval includes determining a sleep time based upon the actual start time and the elapsed data collection time.

6. The method of claim 5 further comprising adjusting the sleep time based on a prediction obtained from historical data corresponding to one or more previous iterations.

7. The method of claim 4 further comprising recording the elapsed data collection time in association with the data collected in the current iteration.

8. The method of claim 7 further comprising using the elapsed data collection time as a measure of error for analyzing the data collected in the current iteration.

9. The method of claim 7 wherein collecting the data comprises reading a set of counters, and further comprising, for at least some of the counters, using the elapsed data collection time in estimating a time value corresponding to when each counter was actually read.

10. The method of claim 1 wherein computing the interval includes determining an elapsed data collection time, and further comprising, estimating a number of processor time slices taken to collect the data based on the elapsed data collection time.

11. The method of claim 10 wherein collecting the data comprises reading a set of counters, and further comprising, for at least some of the counters, using the estimated number of processor time slices in estimating a time value corresponding to when each counter was actually read.

12. The method of claim 10 further comprising using the estimated number of processor time slices as a measure of error for analyzing the data collected in the current iteration.

13. In a computing environment, a system comprising, a software monitor coupled to a set of counters that indicate a state of a computer system, the software monitor reading the set of counters over a number of iterations and associating each iteration with a time value corresponding to when the iteration began, the software monitor including a dynamic adjustment mechanism that dynamically adjusts a sampling interval for starting a next iteration based on an actual start time associated with a current iteration, or a dynamic delay prediction mechanism that dynamically adjusts a sampling interval based on historical data as to when one or more previous iterations have actually started, or a combination of a dynamic adjustment mechanism and a delay prediction mechanism.

14. The system of claim 13 wherein the software monitor further comprises means for determining and recording an elapsed data collection time corresponding to an actual time taken to read the set of counters.

15. The system of claim 14 further comprising, a data collection time compensation mechanism that uses the elapsed data collection time to estimate when at least some of the counters were actually read relative to the time value, or an error measure mechanism that uses the elapsed data collection time as a measure of error associated with at least some of the counter values of at least some of the iterations, or a combination of a data collection time compensation mechanism and an error measure mechanism.

16. The system of claim 15 further comprising means for estimating a number of one or more processor time slices corresponding to the elapsed data collection time, and for at least some of the counters, the data collection time compensation mechanism using the number in the estimate of when at least some of the counters were actually read relative to the time value, or the error measure mechanism using the number in at least one measure of error, or both the data collection time compensation mechanism using the number in the estimate of when at least some of the counters were actually read relative to the time value and the error measure mechanism using the number in at least one measure of error.

17. A computer-readable medium having computer-executable instructions, which when executed perform steps, comprising:
(a) obtaining a desired iteration interval for reading a set of counters in a monitoring test over a plurality of iterations;
(b) obtaining a first current system time;
(c) reading a set of counter values and recording the set of counter values in association with a timestamp corresponding to the first current system time;
(d) obtaining a second current system time and determining an elapsed data collection time based on the first and second current system times;
(e) computing a sleep time based upon the first and second current system times and the desired iteration interval;
(f) waiting for the sleep time; and
(g) returning to step (b) for a further iteration until the monitoring test is complete.

18. The computer-readable medium of claim 17 having further computer-executable instructions comprising adjusting the sleep time prior to step (f) based on a prediction computed from historical data corresponding to one or more previous iterations.

19. The computer-readable medium of claim 17 having further computer-executable instructions comprising estimating at least one actual time a counter value was read based on the elapsed data collection time.

20. The computer-readable medium of claim 16 having further computer-executable instructions comprising estimating at least one error measure based on the elapsed data collection time.
